(19) United States
(12) Patent Application Publication
(10) Pub. No.: US 2009/0219228 A1
(43) Pub. Date: Sep. 3, 2009

(54) Plasma display panel

(76) Inventors: Gi-Young Kim, Suwon-si (KR); Hyoung-Bin Park, Suwon-si (KR); Eui-Jeong Hwang, Suwon-si (KR); Yu-Jeong Cho, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/379,516

(22) Filed: Feb. 24, 2009

(30) Foreign Application Priority Data
Feb. 28, 2008 (KR) 10-2008-0018368

(51) Int. Cl. G09G 3/28

(52) U.S. Cl. 345/60

(57) ABSTRACT

A plasma display panel, includes rear and front substrates facing each other with a predetermined interval therebetween, barrier ribs between the rear and front substrates to define discharge cells, address electrodes on the rear substrate, the address electrodes extending in a first direction to correspond to the discharge cells, display electrodes on the front substrate, the display electrodes extending in a second direction to correspond to the discharge cells, the second direction intersecting the first direction, and a dielectric layer on the front substrate to cover the display electrodes, the dielectric layer having a dielectric constant of about 6 C²/N·m² to about 7 C²/N·m² and a thickness of about 16 μm to about 20 μm.

### BACKGROUND OF THE INVENTION

1. Field of the Invention

Example embodiments relate to a plasma display panel (PDP). More particularly, example embodiments relate to a PDP having reduced reactive power consumption.

2. Description of the Related Art

PDPs refer to display devices that may realize an image using gas discharge. That is, gas discharge in the PDP may generate plasma, thereby triggering emission of vacuum ultraviolet rays. The ultraviolet rays may excite phosphors to emit red, green, and blue visible light as the excited phosphors are stabilized. The PDPs may be self-emissive type display devices and, therefore, may have a quick response characteristic while overcoming a viewing angle limitation. Conventional PDPs, however, may have relatively high power consumption.

The above information disclosed in this Background section is only for enhancement of understanding of the background of the invention and therefore it may contain information that does not form the prior art that is already known in this country to a person of ordinary skill in the art.

### SUMMARY OF THE INVENTION

Example embodiments are therefore directed to a PDP, which substantially overcomes one or more of the disadvantages of the related art.

It is therefore a feature of an embodiment to provide a PDP having a dielectric layer structure with optimized dielectric constant with respect to thickness thereof capable of reducing reactive power consumption of the PDP.

At least one of the above and other features and advantages may be realized by providing a PDP, including rear and front substrates facing each other with a predetermined interval therebetween, barrier ribs between the rear and front substrates to define discharge cells, address electrodes on the rear substrate and extending in a first direction to correspond to the discharge cells, display electrodes on the front substrate and extending in a second direction intersecting the first direction to correspond to the discharge cells, and a dielectric layer that on the front substrate to cover the display electrodes, the dielectric layer having a dielectric constant of about 6 C²/N·m² to about 7 C²/N·m² and a thickness of about 16 μm to about 20 μm. A value of (the dielectric constant)×(the thickness) may be about 96×10⁻⁶ C²/N·m to about 140×10⁻⁶ C²/N·m. A value of (the dielectric constant)/(the thickness) may be about 0.3×10⁶ C²/N·m³ to about 0.437×10⁶ C²/N·m³.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates an exploded perspective view of a PDP according to an example embodiment;

FIG. 2 illustrates a cross-sectional view along line II-II of FIG. 1;

FIG. 3 illustrates a top plan view of an arrangement of barrier ribs and electrodes in the PDP of FIG. 1; and

FIG. 4 illustrates a graph of reactive power as a function of a dielectric layer structure in a 50-inch full-white PDP.

### DETAILED DESCRIPTION OF THE INVENTION

Korean Patent Application No. 10-2008-0018368, filed on Feb. 28, 2008, in the Korean Intellectual Property Office, and entitled: “Plasma Display Panel,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

As used herein, the terms “a” and “an” are open terms that may be used in conjunction with singular items or with plural items.

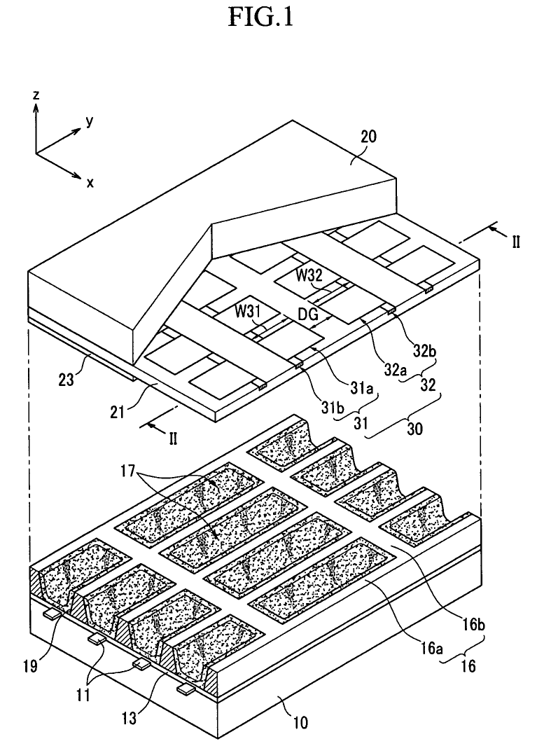

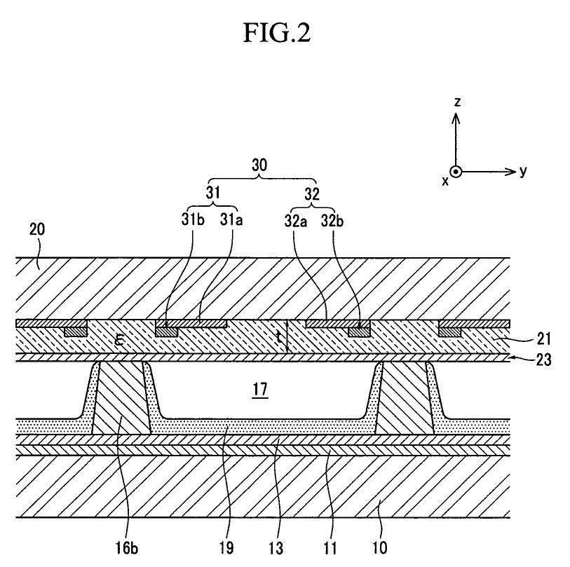

FIG. 1 illustrates an exploded perspective view of a PDP according to an example embodiment, and FIG. 2 illustrates a cross-sectional view along line II-II of FIG. 1. Referring to FIGS. 1 and 2, a PDP, e.g., an alternating current type PDP, of an example embodiment may include rear and front substrates 10 and 20 facing each other with a predetermined interval therebetween, barrier ribs 16 and a plurality of electrodes, i.e., address electrodes 11 and display electrodes 30, between the rear and front substrates 10 and 20, and at least one dielectric layer between the rear and front substrates 10 and 20 having optimized dielectric constant and thickness capable of reducing reactive power consumption of the PDP. In this respect, since the PDP may be driven by capacitance of the dielectric layer, it is noted that the driving power of the PDP may be classified into active power, i.e., power actively contributing to gas discharge by voltage application, and reactive power, i.e., power that does not contribute to the gas discharge but acts as a loss during switching operations.

The barrier ribs 16 of the PDP may be formed between the rear and front substrates 10 and 20, and may define a plurality of discharge cells 17. The discharge cells 17 may be filled with a discharge gas, e.g., neon (Ne) gas, xenon (Xe) gas, or a mixture thereof, and may include phosphor layers 19 on surfaces thereof. Accordingly, when the discharge gas generates vacuum ultraviolet rays in the discharge cells 17, the phosphor layers 19 in the discharge cells 17 may be excited by the vacuum ultraviolet rays to emit visible light as the excited phosphor layers 19 are stabilized. The gas discharge may be induced in the discharge cells 17 via application of voltage to the address electrodes 11 and display electrodes 30.

The address electrodes 11 and display electrodes 30 of the PDP may be arranged between the rear and front substrates 10 and 20, and may intersect each other at regions corresponding to the discharge cells 17. Therefore, the PDP may have, e.g., millions or more unit discharge cells 17 arranged in a matrix pattern. For example, the address electrodes 11 may be formed on an inner surface of the rear substrate 10, i.e., a surface of the rear substrate 10 facing the front substrate 20, and may extend in a first direction, e.g., along the y-axis, so an array of discharge cells 17 may be arranged along an address electrode 11, e.g., each address electrode 11 may extend along a center of a corresponding array of discharge cells 17. The address electrodes 11 may be spaced apart from each other in a second direction, e.g., a space between two adjacent address electrodes 11 may extend along the y-axis.

The address electrodes 11 may be formed of metal having excellent electrical conductivity, e.g., silver (Ag). Since the address electrodes 11 are arranged on the rear substrate 10, the address electrodes 11 may not interfere with the visible light emitted from the discharge cells 17 toward the front substrate 20. The address electrodes 11 may be covered with a first dielectric layer 13, i.e., the address electrodes 11 may be positioned between the first dielectric layer 13 and the inner surface of the rear substrate 10. The first dielectric layer 13 may protect the address electrodes 11 from the discharge gas, and may generate and accumulate wall charges. That is, the first dielectric layer 13 may prevent charged particles, e.g., cations and electrons, from directly colliding with the address electrodes 11 during the gas discharge.

The barrier ribs 16 of the PDP may be formed on the first dielectric layer 13 of the rear surface 10 to define the discharge cells 17. The barrier ribs 16 may include first barrier ribs 16a and second barrier ribs 16b arranged in any suitable pattern, e.g., a grid pattern, to define the discharge cells 17, e.g., in a matrix pattern. The first barrier ribs 16a may extend in the first direction, e.g., along the y-axis, and may be spaced apart from each other in the second direction. The second barrier ribs 16b may extend in the second direction to cross the first barrier ribs 16a, and may be spaced apart from each other in the first direction. It is noted, however, that other configurations of the barrier ribs 16, e.g., the barrier ribs 16 may include only the first barrier ribs 16a along the y-axis in a stripe pattern corresponding to the address electrodes 11 to define discharge cells in a stripe pattern, are within the scope of the present invention.

The phosphor layers 19 of the PDP may be formed in the discharge cells 17, e.g., on side surfaces of the barrier ribs 16, and on a surface of the first dielectric layer 13 facing the discharge cells 17. The phosphor layers 19 may be formed, e.g., by applying a phosphor paste on surfaces of the barrier ribs 16 and the first dielectric layer 13, followed by drying and baking the applied phosphor paste. The phosphor layers 19 may be arranged in any suitable configuration in the discharge cells 17. For example, phosphor layers 19 in discharge cells 17 along the y-direction may be formed of phosphors emitting a substantially same color of visible light, and phosphor layers 19 in discharge cells 17 along the x-axis may be alternately arranged of phosphors emitting red, green, and blue light. That is, the phosphor layers 19 that alternately emit the red, green, and blue visible light may be arranged in the x-direction.

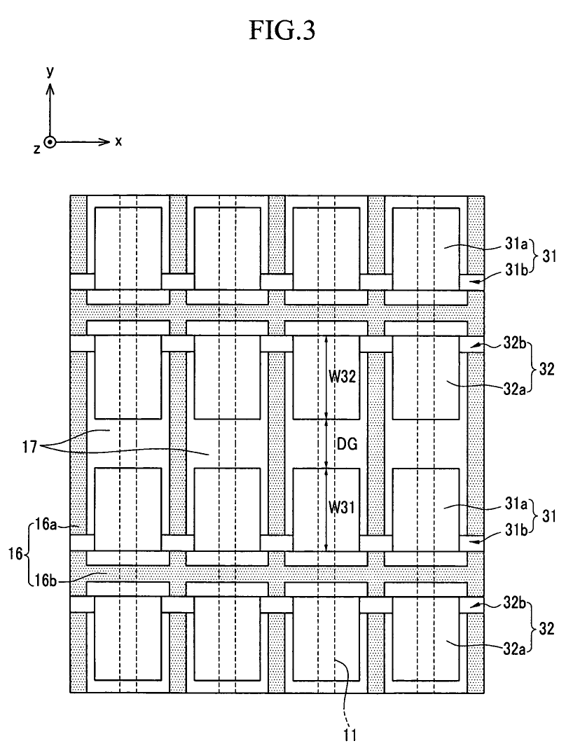

The display electrodes 30 of the PDP may be disposed on the front substrate 20, and may include pairs of first and second electrodes 31 and 32, i.e., each pair of display electrodes 30 may include a first electrode 31, e.g., a sustain electrode, and a second electrode 32, e.g., a scan electrode. The sustain and scan electrodes 31 and 32 may be formed on an inner surface of the front substrate 20, i.e., a surface facing the rear substrate 10, to correspond to the discharge cells 17. The sustain and scan electrodes 31 and 32 may be arranged in an alternating pattern, and may form surface discharge structures at centers of the discharge cells 17 to induce the gas discharge in the discharge cells 17. An exemplary arrangement of the display electrode 30 will be described in more detail below with reference to FIG. 3.

FIG. 3 illustrates a top plan view of an arrangement of the barrier ribs 16 and the display electrodes 30 according to an example embodiment. Referring to FIG. 3, the sustain and scan electrodes 31 and 32 may extend in the x-direction, and may intersect the address electrodes 11. Each of the sustain and scan electrodes 31 and 32 may include a transparent electrode 31a and 32a, respectively, and a bus electrode 31b and 32b, respectively, so voltage signals may be applied to the transparent electrodes 31a and 32a via the bus electrodes 31b and 32b, respectively.

The transparent electrodes 31a and 32a may be arranged above the discharge cells 17, and may be formed of a transparent material, e.g., indium tin oxide (ITO), to secure a sufficient aperture ratio. The transparent electrodes 31a and 32a may extend from respective bus electrodes 31b and 32b, i.e., peripheral portions of the discharge cells 17, toward centers of respective discharge cells 17. That is, as illustrated in FIG. 3, the transparent electrodes 31a and 32a may have respective widths W31 and W32, such that a discharge gap DG may be defined between the transparent electrodes 31a and 32a, e.g., in a center of each discharge cell 17.

The bus electrodes 31b and 32b may extend along the x-axis, and may be formed of a material having excellent electric conductivity, e.g., metal, to effectively apply the voltage signals to the transparent electrodes 31a and 32a. The bus electrodes 31b and 32b may be arranged along opposite ends of the discharge cells 17, so a center of a discharge cell 17 may be between bus electrodes 31b and 32b. Therefore, the voltage signals applied to the bus electrodes 31b and 32b may be transferred to the transparent electrodes 31a and 32a that are connected to the bus electrodes 31b and 32b and correspond to the discharge cells 17.

Referring again to FIGS. 1 and 2, a second dielectric layer 21 may be formed on the front substrate 20 to cover the display electrodes 30, so the display electrodes 30 may be between the front substrate 20 and the second dielectric layer 21. The second dielectric layer 21 may protect the sustain and scan electrodes 31 and 32 during the gas discharge. The second dielectric layer 21 may generate and accumulates wall charges during the gas discharge. The second dielectric layer 21 may be formed of any suitable dielectric material, e.g., the second dielectric layer 21 may include silicon (Si) due to its insulating properties and relatively high strength.

The second dielectric layer 21 may have a dielectric constant (∈) of about 6 C²/N·m² to about 7 C²/N·m², and may have a thickness t of about 16 μm to about 20 μm. The dielectric constant (∈) may be determined, e.g., by capacitance-voltage measurement of a thin film of the dielectric layer and calculating the k value based on the film thickness. As illustrated in FIG. 2, the thickness t of the second dielectric layer 21 may be measured from a lower surface of the second dielectric layer 21 to an upper surface of the second dielectric layer 21 along the z-axis. It is noted that the upper surface of the second dielectric layer 21 may face the front substrate 20, e.g., may be directly on the front substrate 20, and the lower surface of the second dielectric layer 21 may be opposite the upper surface of the second dielectric layer 21 to face away from the front substrate 20.

When the dielectric constant (∈) is greater than about 7 C²/N·m², the reactive power of the PDP may increase. When the dielectric constant (∈) of the second dielectric layer 21 is less than about 6 C²/N·m², the second dielectric layer 21 may require a high baking temperature, e.g., above the transition temperature of glass, thereby making it difficult to apply the second dielectric layer 21 to the PDP.

In particular, a low dielectric constant (∈) of the second dielectric layer 21, e.g., lower than about 6 C²/N·m², may indicate an increased content of silicon therein, thereby requiring a baking temperature of about 1400° C. Since the transition temperature of glass, e.g., a material used to form the front substrate 20, is about 600° C., a temperature of about 1400° C. for baking a high silicon content second dielectric layer 21 may be too high for applying the second dielectric layer 21 to the front substrate 20.

It is noted that although the baking temperature of a dielectric layer may be reduced by adding an alkali material thereto, there is a limit of an amount of the alkali material that may be added to the silicon (Si) in the second dielectric layer 21 while maintaining the physical characteristics of the second dielectric layer 21. Further, when the content of the alkali material is high in the second dielectric layer 21, the second dielectric layer 21 may yellow, thereby reducing light transmittance through the second dielectric layer 21.

In order to use the silicon (Si) as a dielectric material for forming the second dielectric layer 21, the silicon (Si) may be in a form of particles having a diameter of about 2 μm or less formed by, e.g., wet milling. When using the wet milling, a cost for forming silicon particles is high. It is noted that if dry milling is used for forming small silicon particles, the silicon particles may be blown by a jet mill to collide with each other to be further reduced in size, thereby deteriorating yield. For example, when the dielectric constant (∈) is about 12 C²/N·m², the material yield in dry milling may be about 100 kg/hour, and when the dielectric constant (∈) is about 6 C²/N·m², the material yield in dry milling may be reduced to about 20 kg/hour. The material yield may directly affect the manufacturing cost of the second dielectric layer 21.

When the thickness of the second dielectric layer 21 is more than about 20 μm, the reactive power of the PDP may increase and the discharge efficiency of the PDP may deteriorate. When the thickness of the second dielectric layer 21 is less than about 16 μm, thickness uniformity of the second dielectric layer 21 may be reduced, thereby deteriorating mechanical strength and voltage withstanding property of the second dielectric layer 21 against the gas discharge, which may damage the second dielectric layer 21 during the gas discharge.

In particular, when the thickness of the second dielectric layer 21 is below about 16 μm, the thickness of the second dielectric layer 21 may be insufficient to properly cover a total sum of thicknesses of the bus electrodes 31b and 32b with a corresponding black stripe (not shown), i.e., a dark opaque layer on the bus electrodes 31b and 32b, so a resultant portion of the second dielectric layer 21 measured between the bus electrodes 31b and 32b and the lower surface of the second dielectric layer 21 may be thin and may exhibit non-uniform thickness. For example, when the thickness of the bus electrodes 31b and 32b on the transparent electrodes 31a and 32a is about 5 μm or more, a total thickness of the bus electrodes 31b and 32b with the corresponding black stripes may be 10 μm. Since the thickness of the second dielectric layer 21 coated on the sustain and scan electrodes 31 and 32 may be reduced during the baking process, a dielectric layer having a thickness of less than about 16 μm may be too thin, thereby deteriorating mechanical strength and voltage withstanding property of the second dielectric layer 21, which may damage the second dielectric layer 21 and the PDP.

If the second dielectric layer 21 has a dielectric constant (∈) of about 6 C²/N·m² to about 7 C²/N·m², and a thickness t of about 16 μm to about 20 μm, a product value (∈×t), i.e., value of (the dielectric constant)×(the thickness), may be about 96×10⁻⁶ C²/N·m to about 140×10⁻⁶ C²/N·m. The value of (the dielectric constant)×(the thickness) may correspond to a value of the reactive power consumed by switching elements during driving of the PDP. When the value of (the dielectric constant)×(the thickness) increases, the reactive power consumption may increase.

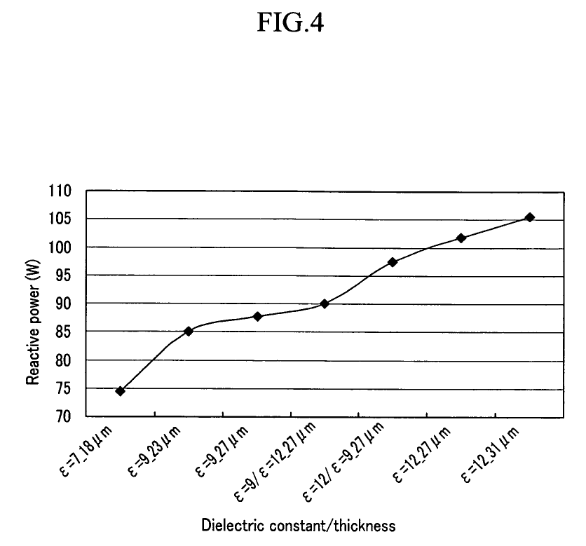

When the value of (the dielectric constant)×(the thickness) (∈×t) is less than about 96×10⁻⁶ C²/N·m, the dielectric constant (∈) may be less than about 6 C²/N·m² and/or the thickness t of the second dielectric layer 21 may be less than about 16 μm, thereby making application of the second dielectric layer 21 to the PDP impossible or damaging the second dielectric layer 21 as discussed previously. When the value of (the dielectric constant)×(the thickness) (∈×t) is more than about 140×10⁻⁶ C²/N·m, the dielectric constant (∈) may be more than about 7 C²/N·m² and/or the thickness t of the second dielectric layer 21 may be more than about 20 μm, thereby increasing the reactive power of the PDP as discussed previously. For example, as illustrated in FIG. 4, when the dielectric constant (∈) is greater than about 7 C²/N·m² and/or the thickness t of the second dielectric layer 21 is greater than about 20 μm, the reactive power of the PDP may increase in proportion to an excess value of the dielectric constant (∈) or the thickness t. In addition, bismuth (Bi) may be added to the PDP, thereby increasing the manufacturing costs thereof.

It is noted that the graph in FIG. 4 illustrates reactive power consumption of a 50-inch full-white PDP with respect to varying dielectric constants and thickness of a second dielectric layer therein. In FIG. 4, the first point on the graph indicates a second dielectric layer 21 according to an example embodiment, i.e., a second dielectric layer 21 having a dielectric constant of 7 C²/N·m² and thickness of 18 μm, so a corresponding PDP is exhibiting a reactive power consumption of about 75 W. The remaining points on the graph of FIG. 4 indicate dielectric layers having dielectric constant greater than about 7 C²/N·m², i.e., gradually increasing dielectric constants, and thicknesses greater than about 20 μm, so corresponding PDP are exhibiting reactive power consumption substantially higher than about 75 W. The PDPs used to illustrate the graph of FIG. 4 were realized by currently-used processes and/or materials.

In addition, the second dielectric layer 21 may exhibit a quotient value (∈/t), i.e., value of (the dielectric constant)/(the thickness), of about 0.3×10⁻⁶ C²/N·m³ to about 0.437×10⁻⁶ C²/N·m³. The value of (the dielectric constant)/(the thickness) may correspond to active power consumption of the PDP. That is, since an external voltage is applied to the discharge cells 17 of the PDP in order to induce gas discharge therein, an actual voltage applied to the discharge cells 17 may be determined by the value of (the dielectric constant)/(the thickness).

When the value of (the dielectric constant)/(the thickness) (∈/t) is less than about 0.3×10⁻⁶ C²/N·m³, capacitance of the PDP may be reduced, i.e., the dielectric constant (∈) may be less than about 6 C²/N·m² and/or the thickness t of the second dielectric layer 21 may be greater than about 20 μm. As discussed previously, an increased thickness t of the second dielectric layer 21 may increase reactive power consumption of the PDP, and a reduced dielectric constant (∈) of the second dielectric layer 21 may cause damage thereto. Even though reduced capacitance of the second dielectric layer 21 may improve discharge efficiency of the PDP, the discharge voltage of the PDP may increase, e.g., because sustain voltage may vary with respect to the dielectric constant and thickness of the second dielectric layer 21, thereby increasing the reactive power consumption of the PDP.

For example, when the value of (the dielectric constant)/(the thickness) (∈/t) is less than about 0.3 and the dielectric constant (∈) is about 12, the sustain voltage may increase by about 2.5 V as a thickness of a dielectric layer increases by about 1 μm from about 35 μm. When the dielectric constant (∈) is about 6, the sustain voltage may increases by about 2.5 V as the thickness t of the second dielectric layer 21 increase by about 0.5 μm from about 16 μm. That is, a driving voltage of the PDP having the second dielectric layer 21 with the thickness of about 16 μm may be higher than that of the PDP having a dielectric layer with the thickness of about 35 μm by about 20 V. As a result, as the sustain voltage increases, the manufacturing cost of a driving circuit and the power consumption of the PDP may increase.

When the value of (the dielectric constant)/(the thickness) (∈/t) is greater than about 0.437×10⁻⁶ C²/N·m³, the capacitance of the PDP may significantly increase, i.e., the dielectric constant (∈) may be greater than about 7 C²/N·m² and/or the thickness t of the second dielectric layer 21 may be less than about 16 μm. As discussed previously, a reduced thickness t of the second dielectric layer 21 may reduce thickness uniformity of the second dielectric layer 21, thereby requiring a new dielectric material coating process and deteriorating mechanical strength and a voltage withstanding property of the second dielectric layer 21. Further, the reactive power consumption may increase and the luminance efficiency of the PDP may decrease. For example, when the value of (the dielectric constant)/(the thickness) (∈/t) is greater than about 0.437 C²/N·m³, the capacitance of the PDP may increase by about 46%, as compared to the capacitance of the PDP when the value of (the dielectric constant)/(the thickness) (∈/t) is about 0.3 C²/N·m³, so the corresponding reactive power consumption of the PDP may increase by about 46% as well.

As illustrated in FIGS. 1-2, the PDP may further include a protective layer 23 to cover the second dielectric layer 21. For example, the protective layer 23 may be formed of a transparent material, e.g., MgO, for transmitting visible light. The protective layer 23 may protect the second dielectric layer 21 and may increase a secondary electron emission coefficient.

The PDP may operate as follows. Discharge cells 17 of the PDP to be operated may be selected, i.e., turned on, by address discharge induced by voltage signals applied to the address and scan electrodes 11 and 32. The selected discharge cells 17 may be driven using sustain discharge induced by application of voltage signals to the sustain and scan electrodes 31 and 32 that correspond to the selected discharged cells 17. Inducing the sustain discharge may cause gas discharge as discussed previously, thereby emitting visible light toward the front substrate 20 to realize an image.

A PDP according to an example embodiment may include a dielectric layer covering the display electrodes and designed to have a dielectric constant (∈) of about 6 C²/N·m² to about 7 C²/N·m² and a thickness t of about 16 μm to about 20 μm, thereby improving the luminance efficiency of the PDP by reducing power consumption, e.g., reactive power consumption, during driving of the PDP.

Example embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel, comprising:
rear and front substrates facing each other with a predetermined interval therebetween;
barrier ribs between the rear and front substrates to define discharge cells;
address electrodes on the rear substrate, the address electrodes extending in a first direction to correspond to the discharge cells;
display electrodes on the front substrate, the display electrodes extending in a second direction to correspond to the discharge cells, the second direction intersecting the first direction; and
a dielectric layer on the front substrate to cover the display electrodes, the dielectric layer having a dielectric constant of about 6 C²/N·m² to about 7 C²/N·m² and a thickness of about 16 μm to about 20 μm.

2. The plasma display panel as claimed in claim 1, wherein a value of (the dielectric constant)×(the thickness) is about 96×10⁻⁶ C²×N·m to about 140×10⁻⁶ C²×N·m.

3. The plasma display panel as claimed in claim 1, wherein a value of (the dielectric constant)/(the thickness) is about 0.3×10⁶ C²/N·m³ to about 0.437×10⁶ C²/N·m³.
